(19) United States
(12) Patent Application Publication
(10) Pub. No.: US 2016/0020468 A1
(43) Pub. Date: Jan. 21, 2016

(54) FUNCTIONAL GRADING OF CATHODE INFILTRATION FOR SPATIAL CONTROL OF ACTIVITY

(71) Applicant: West Virginia University, Morgantown, WV (US)

(72) Inventors: Kirk Gerdes, Morgantown, WV (US); Shiwoo Lee, Morgantown, WV (US); Suryanarayana Raju Pakalapati, Andhra Pradesh (IN); Ismail Celik, Morgantown, WV (US)

(21) Appl. No.: 14/804,492

(22) Filed: Jul. 21, 2015

Related U.S. Application Data
(60) Provisional application No. 62/026,876, filed on Jul. 21, 2014.

(51) Int. Cl. H01M 4/86; H01M 8/12; H01M 4/90

(52) U.S. Cl. CPC H01M 4/8642; H01M 4/905; H01M 8/12; H01M 2004/8689; H01M 2008/1293; H01M 2300/0071

(57) ABSTRACT

Disclosed are various embodiments for functional grading of electrode infiltration for spatial control of activity. In one embodiment, a system comprises a plurality of electrodes. At least one electrode of the plurality of electrodes comprises a non-uniform distribution of an infiltrate applied along a length of the at least one electrode.

### CROSS-REFERENCE TO RELATED APPLICATIONS

This application claims priority to copending U.S. Provisional Patent Application titled “FUNCTIONAL GRADING OF CATHODE INFILTRATION FOR SPATIAL CONTROL ACTIVITY,” filed on Jul. 21, 2014 and assigned application No. 62/026,876, which is incorporated by reference herein in its entirety.

### STATEMENT REGARDING FEDERALLY SPONSORED RESEARCH OR DEVELOPMENT

This invention was made with government support under agreement DE-FC26-05NT42248 awarded by the National Academy of Sciences. The Government has certain rights in the invention.

### BACKGROUND

A solid oxide fuel cell (SOFC) has only three active components: 1) the anode where fuel is used to produce oxygen vacancies, 2) the electrolyte that transfers the oxygen vacancies to the cathode while preventing the transfer of electrons, and 3) a cathode that reduces oxygen to annihilate the oxygen vacancies. The performance of SOFCs can be limited by the effectiveness of the cathode at reducing oxygen, the rate of oxygen reduction reaction (ORR), and by the transport of the resulting oxygen to the electrolyte. The structure of the cathode can affect one or more of these mechanisms.

### SUMMARY

Included are systems related to functional grading of cathode infiltration for spatial control of activity. One embodiment of a system, among others, includes a system that comprises a plurality of electrodes, wherein at least one electrode of the plurality of electrodes comprises a non-uniform distribution of an infiltrate applied along a length of the at least one electrode.

Another embodiment of a system, among others, includes an electrochemical device that comprises an electrode and a surface-modifying layer disposed in a non-uniform configuration along a surface of the electrode.

Other embodiments, systems, features, and advantages of this disclosure will be or will become apparent to one with skill in the art upon examination of the following drawings and detailed description. It is intended that all such additional apparatuses, features, and advantages be included within this description and be within the scope of the present disclosure.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of a composite structure of a cathode functional layer in accordance with various embodiments of the present disclosure.

FIG. 2 is a schematic diagram depicting the composite structure of the cathode functional layer of FIG. 1 in accordance with various embodiments of the present disclosure.

FIGS. 3, 4A, and 4B are plots illustrating examples of infiltrate loading as a function of the electrode linear position in accordance with various embodiments of the present disclosure.

FIG. 5 is a graphical representation of an example of normalized polarization resistance as a function of magnitude of uniform infiltrate loading of FIG. 3 in an anode supported button cell in accordance with various embodiments of the present disclosure.

FIGS. 6A, 6B, and 6C are graphical representations of examples of simulated profiles of local temperature, current density, and cathode overpotential with respect to cell length along the gas flow direction at the centerline of a co-flow planar cell in accordance with various embodiments of the present disclosure.

FIGS. 7A and 7B are graphical representations of examples of predicted contours of cathode overpotential (in Volts) inside a co-flow planar SOFC for the baseline (uninfiltrated) case and a graded infiltrate case of FIG. 4A in accordance with various embodiments of the present disclosure.

FIGS. 8A-8D are plots illustrating examples of infiltrate loading distribution as a function of the electrode linear position in accordance with various embodiments of the present disclosure.

FIG. 9 is a graphical representation of an example of normalized polarization resistance as a function of uniform infiltrate loading of an inactive infiltrate material in accordance with various embodiments of the present disclosure.

FIGS. 10A-10G are plots illustrating examples of infiltrate loading distributions on two electrodes in accordance with various embodiments of the present disclosure.

FIGS. 11A-11G are plots illustrating examples of a plurality of infiltrate loading distributions on a single electrode in accordance with various embodiments of the present disclosure.

FIGS. 12A-12E are graphical representations of examples of cathode overpotential in a baseline (uninfiltrated) case, a standard (uniform infiltrate distribution) case, and a functionally graded infiltrate distribution case for different air utilizations in accordance with various embodiments of the present disclosure.

FIG. 12F is a table summarizing the cathode overpotential differences for the different air utilizations of FIGS. 12A-12E in accordance with various embodiments of the present disclosure.

### DETAILED DESCRIPTION

Disclosed herein are various examples related to functional grading of cathode infiltration for spatial control of activity. Reference will now be made in detail to the description of the embodiments as illustrated in the drawings, wherein like reference numbers indicate like parts throughout the several views.

Catalytically (or electrocatalytically) active materials can be inserted (infiltrated) into a porous electrode of a solid oxide fuel cell to control cell activity through a spatial domain spanning the entire cell length/width. Cathode infiltration can improve the electrochemical activity of the cathode. Spatially distributed control of cell performance may be achieved by controlling the local magnitude of (electro)catalyst deposition within the electrode structure. Functional grading of the electrocatalyst deposition affects local magnitudes and/or gradients in other critical operating parameters including, e.g., temperature, current density, and/or overpotential. Controlling the local magnitude of (electro)catalyst deposition can functionally grade solid oxide fuel cell (SOFC) electrode activity over a macroscopic domain.

Chemical activity inside the electrode of a SOFC is globally controlled (i.e. controlled broadly over a domain the size of a full cell) via the applied current density or applied voltage. Conventional fuel cell designs provide no means for control of reaction processes in a spatial domain smaller than the electrode, and typically provide no means for control of reaction rates from cell to cell. The reactants tend towards the thermodynamic equilibrium dictated by the (locally uncontrolled) current density at a rate that can lead to unwanted distributions in operating parameters. The unwanted distributions in operating parameters can result in intensified system stress and cell performance degradation. Local control over the reaction rates can be achieved by controlling the distribution of (electro)catalytic material, which in turn facilitates control of the local chemical activity of the anode and cathode.

Global (average) current density is controlled in a conventional SOFC stack through the application of a load. The local current density is dictated by the specific reaction conditions, which are principally influenced by: 1) the thermodynamic operating state and 2) the local material structure. Conventional SOFC electrodes are uniformly constructed in the spatial domain parallel to the convective fuel/oxidant flows, therefore local material structure is invariant as fuel/oxidant passes through the cell. However, the gas composition within the flow field changes as gases are consumed in the electrode reactions. The changing gas compositions on both electrodes generate a local overpotential gradient, which may result in local domains of non-uniform current density. The gradient in local current density throughout the cell spatial domain leads to gradients in local performance. To compensate for this, the electrode microstructure can be functionally graded parallel to the gas flow field via infiltration, thereby altering the local microstructure and consequently the local current density.

In conventional mixed phase fuel cell electrodes, the electric fields are locally established between phases possessing different electrostatic potentials. Local electrostatic potential in SOFC electrodes is dictated by local oxygen partial pressure (P_{O2}) and/or the local current density. Certain modes of electrode degradation are active in the presence of an electric field, and the magnitude of degradation can be influenced by the magnitude of the field. Thus, degradation rates and/or cumulative effects may be locally distributed according to the distribution in the electric field. Distributions in degradation may produce unacceptable local cell performance and/or complete cell failure, even though the global cell performance otherwise appears to remain acceptable. By microstructural tailoring of the electrodes, the overpotential distributions can be made more uniform, which engenders local control of primary degradation processes associated with the overpotential condition.

Conventional SOFC electrodes also allow thermo-chemical reactions to proceed uninhibited towards the thermodynamic equilibrium. This is especially true for hydrocarbon reforming reactions, which typically occur rapidly at the gas inlet edge of the SOFC anode. The methane reforming reaction in particular is strongly endothermic, and a significant and sharp temperature gradient may exist in a short spatial domain of the gas flow field. Uneven thermal profiles result in thermally induced mechanical stress across the cell, and in severe cases may lead to cell degradation or mechanical failure. Functional grading of the electrode allows for control of the local activity of the fuel cell electrode towards the thermo-chemical reactions, and dampens the uneven distribution of temperature across the cell parallel to the gas flow field.

Conventional SOFC electrodes allow thermo-chemical reactions to proceed uninhibited towards the thermodynamic equilibrium. This is especially true for hydrocarbons and/or other carbon containing materials, which may reform in the SOFC anode based upon to either of the following reactions:

CH₄+H₂O→H₂+CO₂, or

2CO→C(s)+CO₂.

Certain of the reforming reactions are accelerated by the presence of a suitable catalyst. The functional grading can control the rate of these unwanted reactions to suppress and/or distribute the associated degradation.

Overall, functional grading modifies and/or controls the local activity of the SOFC electrodes, more evenly distributes the thermodynamic state variables (temperature, internal energy), and can more evenly distribute cell degradation across the entire cell. The processing parameters and material deposition can be manipulated to alter the magnitude of application of the surface-modifying phase, correlate the control of infiltrate deposition with (electro)chemical activity, and provide a tailored electrode of controlled activity and stability.

By controlling the local magnitude of deposition of (electro)catalyst materials through a spatial domain that is approximately equivalent to the trans-cell electrode dimension, the local electrochemical activity of SOFC electrodes can be controlled. A composite electrode composed can be formed of a single or multi-phase scaffold and a surface-modifying layer that is electrochemically active towards conventional solid oxide fuel cell reactions. The single or multi-phase scaffold can be infiltrated with a precursor solution of metal salts and polymeric additives, and the composite electrode can be heat-treated to decompose the salt and polymeric additives. The resulting single or multi-phase multi-phase scaffold characteristically has either a mixed ionic/electronic conducting phase or at least one primary ionic conducting phase and one primary electronic conducting phase to intrinsically function as a cathode. A surface-modifying layer (or phase) can be applied to the boundaries and surface regions of the conducting phase(s) to support (electro)catalytic reaction processes. The concentration of infiltrate, which is a source of activity and stability, can be locally controlled.

SOFC electrode structure and electrode infiltration will now be discussed to allow the capabilities of the functional grading to be distinguished from the capabilities of a conventional electrode. While a two-phase cathode is used as the representative example in the discussion, a single phase cathode can also be used as a backbone. A two-phase composite composed of an ionic conductor and an electronic conductor (or a mixed ionic-electronic conductor, MIEC) is widely accepted as an electrode functional layer structure by commercial SOFC manufacturers. A composite electrode structure possesses a high population of three phase boundaries (TPB) because the ionic conducting phase effectively extends the electrolyte towards the cathode. The TPB is a physical location where the electrolyte, air, and electrode meet. The TPB is a geometrical parameter that correlates strongly to the performance of fuel cells.

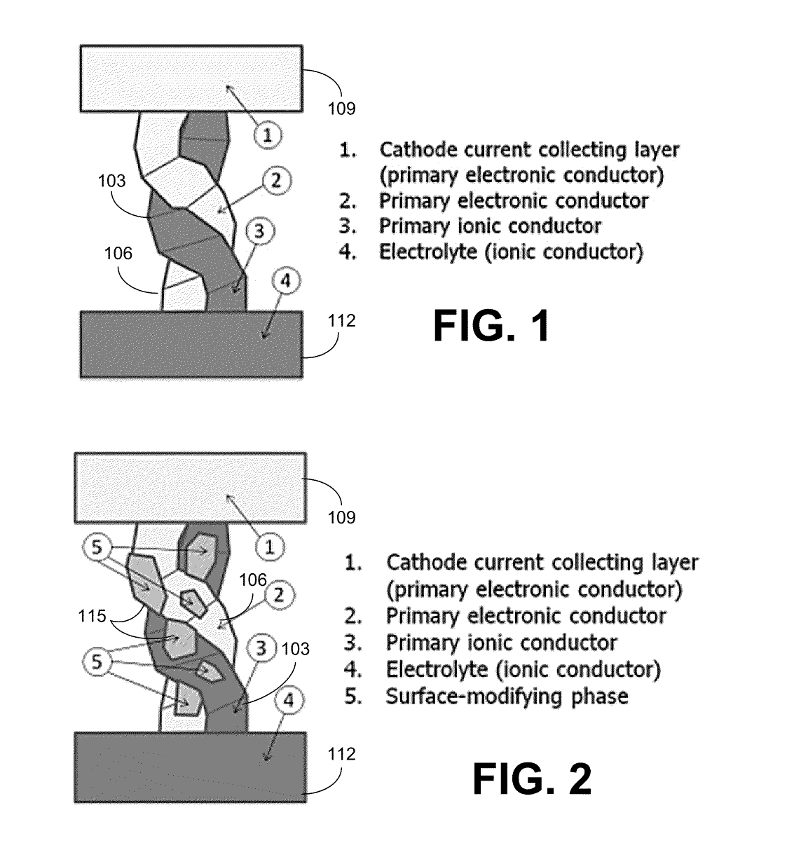

Referring to FIG. 1, shown is a schematic diagram depicting an example of the composite structure of a cathode functional layer. In the example of FIG. 1, the composite structure includes a primary ionic conductor 103 and primary electronic conductor 106 extending between a cathode current collecting layer 109 and an electrolyte 112. A primary ionic conducting phase (or conductor) 103 is the phase classification that includes pure ionic conductors (e.g., yttria-stabilized zirconia, YSZ, etc.) and mixed ionic-electronic conductors, which have a predominant ionic conductivity compared to the electronic conductivity (e.g., doped cerium(IV) oxide, CeO₂, etc.). A primary electronic conducting phase (or conductor) 106 is the phase classification that includes electronic conductors (e.g., metals, etc.) and a mixed ionic-electronic conductor, which has a predominant electronic conductivity compared to ionic conductivity (etc., lanthanum strontium cobalt ferrite (LSCF), lanthanum strontium manganite (LSM), lanthanum strontium cobaltite (LSC), etc.).

The baseline cell may be fashioned from a variety of materials. For example, a commercially available anode-supported cell from MSRI (Salt Lake City, Utah) can be used as a baseline cell. The MSRI cell includes a LSCF cathode current collecting layer 109 (e.g., about 50 μm in thickness), a SDC-LSCF (samarium doped ceria-lanthanum strontium cobalt ferrite) cathode functional layer (e.g., about 10 μm), a SDC blocking layer (e.g., about 1-2 μm), a YSZ electrolyte (e.g., about 10 μm) and a Ni/YSZ anode (e.g., about 750 μm). However, the baseline cell is not limited to cells made by specific manufacturers or to the particular materials cited above.

Referring next to FIG. 2, shown is a schematic diagram depicting the composite structure of the cathode functional layer of FIG. 1, which was surface-modified by separately applying an (electro) catalytic phase (e.g., infiltrate) on the surfaces of the scaffold to form the surface-modifying layer (or phase) 115. The surface-modifying phase 115 can affect activation-polarization resistance and performance stability of the backbone, and directly impact the electrode processes and cell responses (e.g., thermal evolution, cell overpotential, electrode degradation, etc.) that can be controlled by these properties. The composite cathode can be formed by modifying an existing multi-phase scaffold with a surface-modifying layer that is electrochemically active. The microstructure of the composite cathode affects the electrochemical performance and is manipulated by controlling the surface chemistry of the materials.

The surface-modifying (electro)catalytic phase 115 can be ionically conductive (e.g., doped CeO₂, etc.), electronically conductive (e.g., LSM, Pt, etc.), or mixed ionic-electronic conductive (e.g., LSCF, La₁₋ₓSrₓCoO₃ (LSCo), Pr₁₋ₓSrₓMnO₃ (PSCo), etc.). The material can also be categorized by crystallographic structure, which is related with electronic defect chemistry affecting the charge transfer process, ionic diffusion, or molecular incorporation processes at surfaces. For example, it can be a multi-component oxide selected from perovskite structure (e.g., LSCo, PSCo, Ba₁₋ₓSrₓCo_{y}Fe_{1-y}O_{3-δ} (BSCF), etc.) or perovskite-related structure including K₂NiF₄ (e.g., (La₁₋ₓSrₓ)₂CoO₄ (LSCo214), (Pr₁₋ₓSrₓ)₂CoO₄ (PSCo214), etc.). Precious metal doped perovskite or perovskite-related structures with high catalytic activity and good structural stability can also be used.

Further element by element details will be described with reference to specific embodiments in which functionally controlled cathodes are fabricated for a solid oxide fuel cell. It should be understood, however, that functional grading is applicable more generally to the infiltration of porous substrates in conjunction with the fabrication of other electrochemical devices and devices and/or structures of other types.

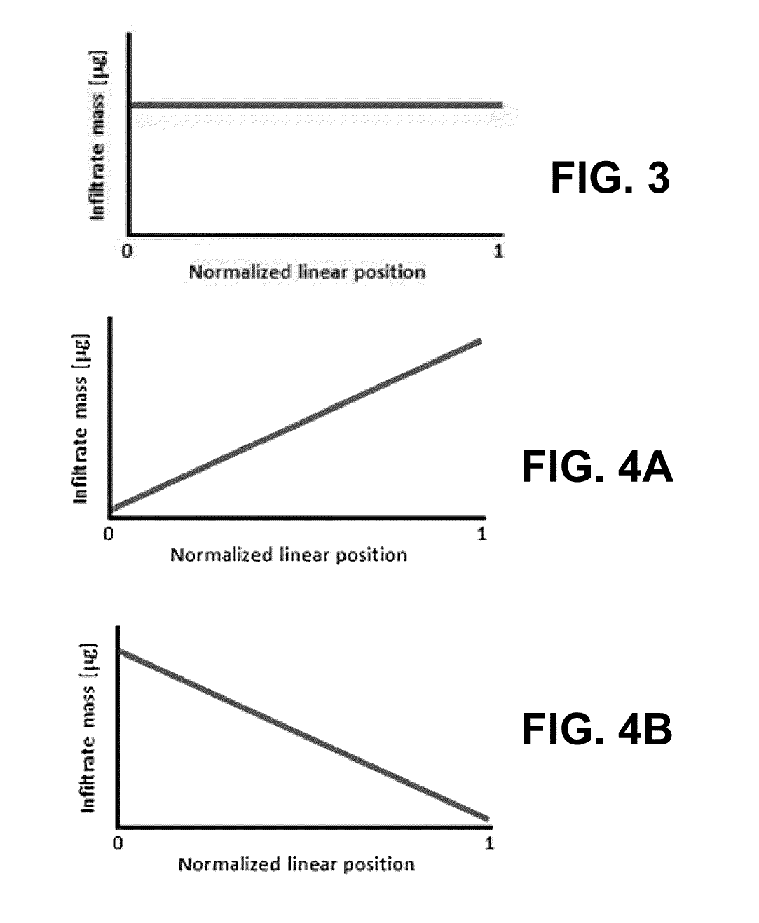

Conventional infiltration is uniformly applied to an electrode, with no variation in local microstructure along the spatial domain of the flow field (parallel to the cell surface). The distribution of infiltrate within the electrode microstructure of a state-of-the-art commercial cell can be qualitatively described by the graph in FIG. 3. The infiltrate loading is qualitatively depicted in FIG. 3 as a function of the electrode linear position. The normalized location at 0 corresponds to the stack (or cell) inlet, and normalized location at 1 corresponds to stack (or cell) outlet.

In various embodiments of the present disclosure, one or more infiltrates can be applied non-uniformly along the length of the electrode to enhance or adjust performance of the cell. For example, an infiltrate can be applied to the electrode with a linear gradient in the local infiltrate concentration as a function of position parallel to the flow field. FIGS. 4A and 4B qualitatively depict linearly graded infiltrate deposition profiles across an electrode. Linearly graded spatial deposition of a single phase (electro)catalytic material in the cell plane can improve primary local reaction activity. The application of a surface-modifying layer (or phase) 115 (e.g., infiltrate material) may be linearly increasing or decreasing as shown in FIGS. 4A and 4B, respectively, and may begin and/or end at a zero or non-zero concentration. The normalized location at 0 corresponds to the stack (or cell) inlet, and normalized location at 1 corresponds to stack (or cell) outlet.

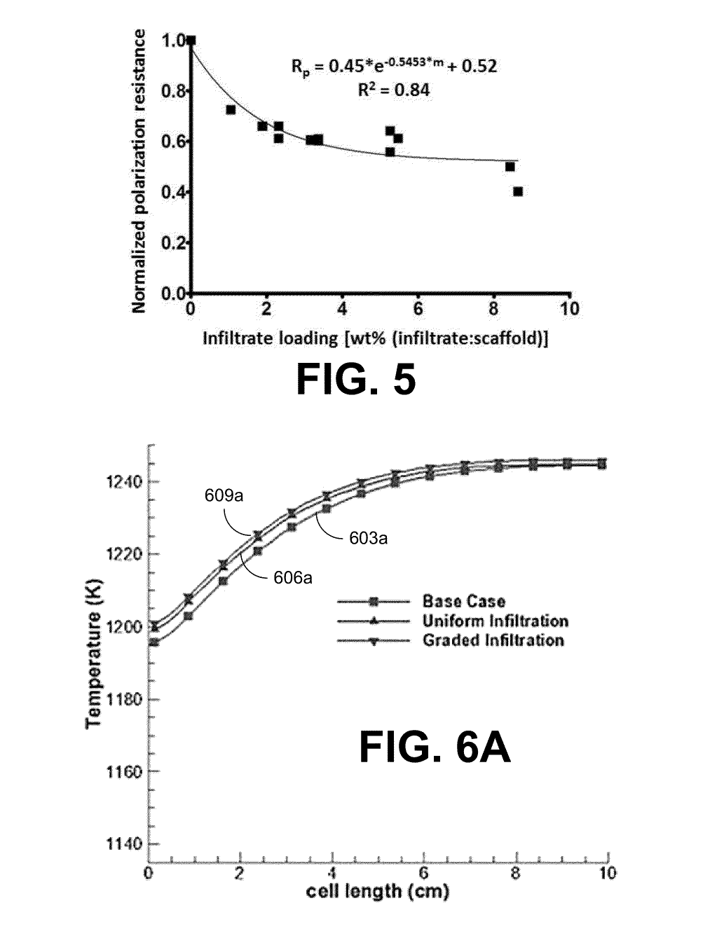

Gradients in the magnitude of infiltrate deposition permit local control of reaction activity. This concept is demonstrated by data collected for uniformly infiltrated button cell specimen possessing varying infiltrate concentrations. Referring to FIG. 5, shown is a plot of measured polarization resistance as a function of magnitude of uniform infiltrate loading in an anode supported button cell composed of LSM-YSZ cathode, YSZ electrolyte, and Ni/YSZ anode produced by MSRI and operated in hydrogen/air at 750° C. The infiltrate is LSC. Under the tested conditions, polarization resistance decreases with infiltrate loading according to a one-phase exponential decay function. Each specimen represents the local performance that could be expected in discrete regions of a functionally infiltrated cell, and clearly demonstrates the impact on local reaction activity and local cell conditions. Power density as a function of infiltrate loading is also depicted in FIG. 5, with the cathode activation represented as a decrease in polarization resistance.

By controlling the local reaction activity, the local operating conditions of the cell consequently may be controlled. Local operating conditions include temperature, current density, overpotential, and degradation rates among other parameters. Simulations can be used to properly predict the impact of a linear gradient in infiltration with corresponding changes in cell output parameters.

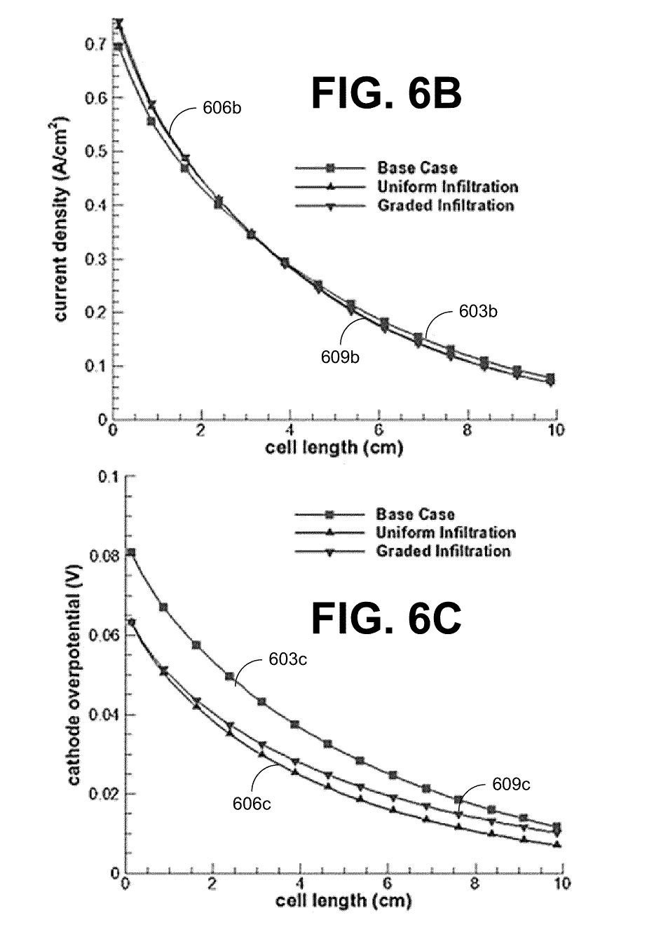

For illustrative purposes, assume that a linear change in local activity will result. A linear activity gradient is applied to a 3D SOFC simulation and the effect on local thermal gradients, local current density, and local overpotential gradients along the cell centerline are depicted in FIGS. 6A-6C. FIG. 6A shows simulated profiles of local temperature, FIG. 6B shows current density, and FIG. 6C shows cathode overpotential along the gas flow direction at the centerline of a typical co-flow planar cell. Curves 603a-603c are the base case, curves 606a-606c are uniformly infiltrated cases, and curves 609a-609c are functionally graded cases. The simulation shows that the absolute temperature gradient (curve 609a) across the cell is weakly diminished, the global average current density (curve 609b) is maintained, and both the average magnitude and absolute gradient in overpotential (curve 609c) decrease using the functionalized cathode with graded infiltration.

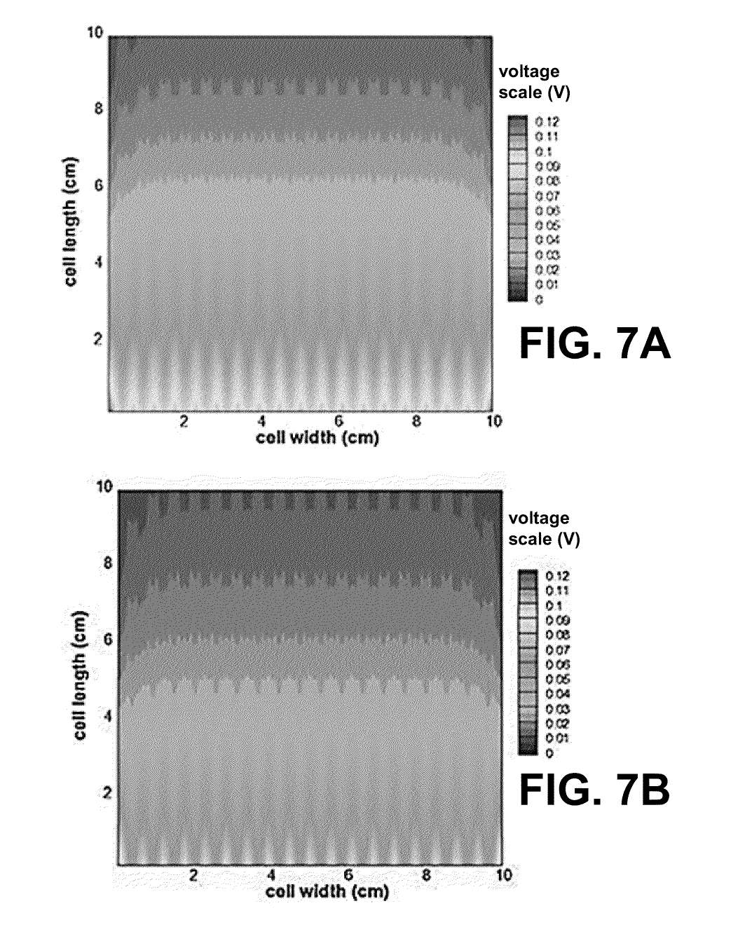

The contours of the simulation results for cathode overpotential (in Volts) were also plotted in two dimensions (length and width) as graphically depicted in FIGS. 7A and 7B for the base case and graded infiltrate case, respectively, inside a typical co-flow planar SOFC. FIG. 7A depicts the baseline (uninfiltrated) cell. In FIG. 7B, the linear gradient in local activity is applied from the bottom of the two dimensional (2D) plot (cell inlet) to the top of the 2D plot (cell outlet). Qualitatively, FIG. 7B features fewer and wider domains, and no domains of value greater than 100 mV. The experimental and computational results validate that a linear functional grading of infiltrate will dampen gradients in operating parameters and enhance cell performance.

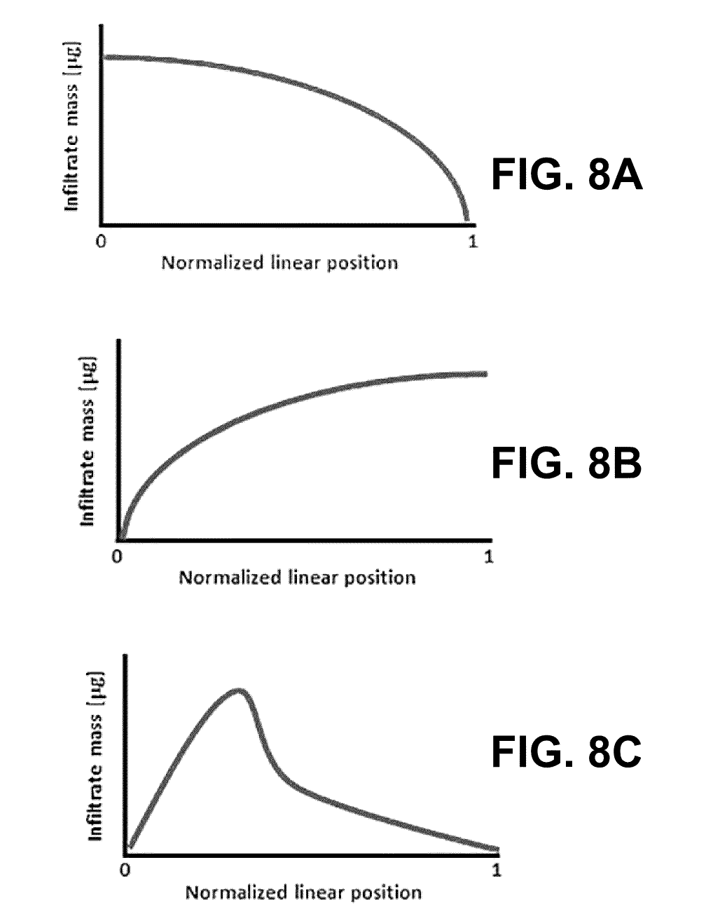

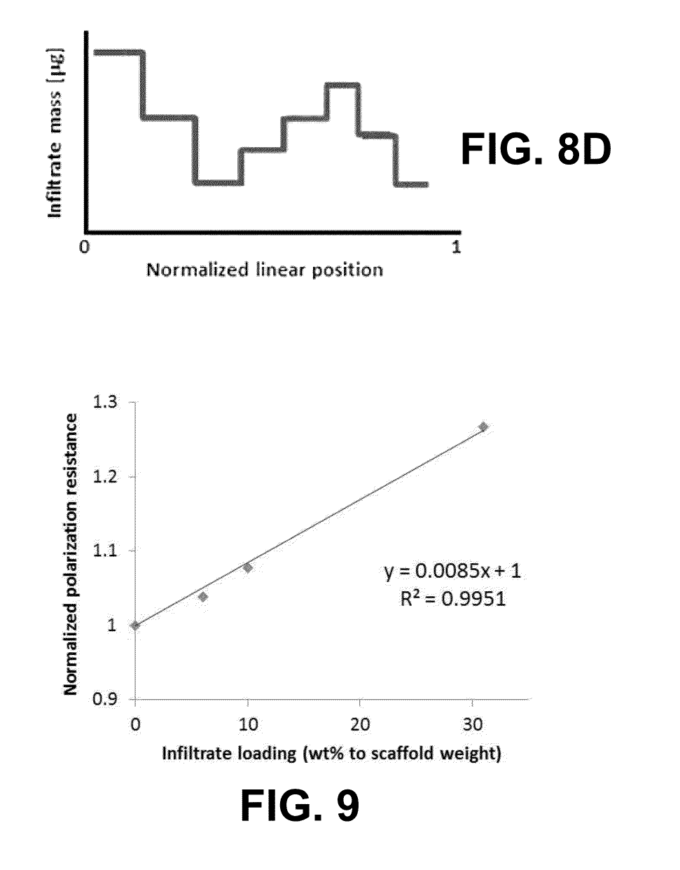

Non-linear grading deposition of a single phase (electro)catalytic material in the cell plane can also be used to improve primary local reaction activity. Non-linear grading of infiltrate can control the local electrode activity given the local operating conditions. The functional grading may be monotonically increasing/decreasing or complex, continuous or discrete, and/or various combinations thereof. Grading may begin and/or end at a zero or non-zero value. FIGS. 8A-8D depict various examples of non-linear gradients of infiltrate loading. FIGS. 8A and 8B illustrate examples of exponentially or quadratically decreasing or increasing infiltrate distribution from the stack (or cell) inlet (normalized location 0) to the stack (or cell) outlet (normalized location at 1), respectively. FIG. 8C shows an example of a non-linear infiltrate distribution that includes a peak infiltration located between minimum infiltration at the stack (or cell) inlet and outlet. FIG. 8D shows an example of a stepped distribution of infiltrate along the length of the cell. While not explicitly depicted, other non-linear distributions are also possible. For instance, infiltrate can be distributed with multiple peaks and/or minimums. Non-continuous distributions may also be applied.

Functionally grading deposition of single (electro)catalytic material in the cell plane can also be utilized to suppress primary local reaction activity. In addition to enhancing cell performance, infiltrate material can be added to inhibit a reaction in order to produce a desirable result. For example, applying material to inhibit endothermic methane reforming reactions on the anode can enable dampening of thermal gradients and distribution over a larger spatial domain. By dampening the thermal gradients, the generated thermal stress would be less than that exhibited by an uninfiltrated cell. An example of activity suppression by infiltration is shown in FIG. 9. Here, the known insulating material lanthanum strontium zirconate (LSZ) is applied to the cathode and activity suppression is evident as a function of loading. FIG. 9 shows a plot of the normalized polarization resistance associated with deposition of an inactive infiltrate material. The cell polarization is observed to decrease in linear proportion to the magnitude of deposited cathode infiltrate.

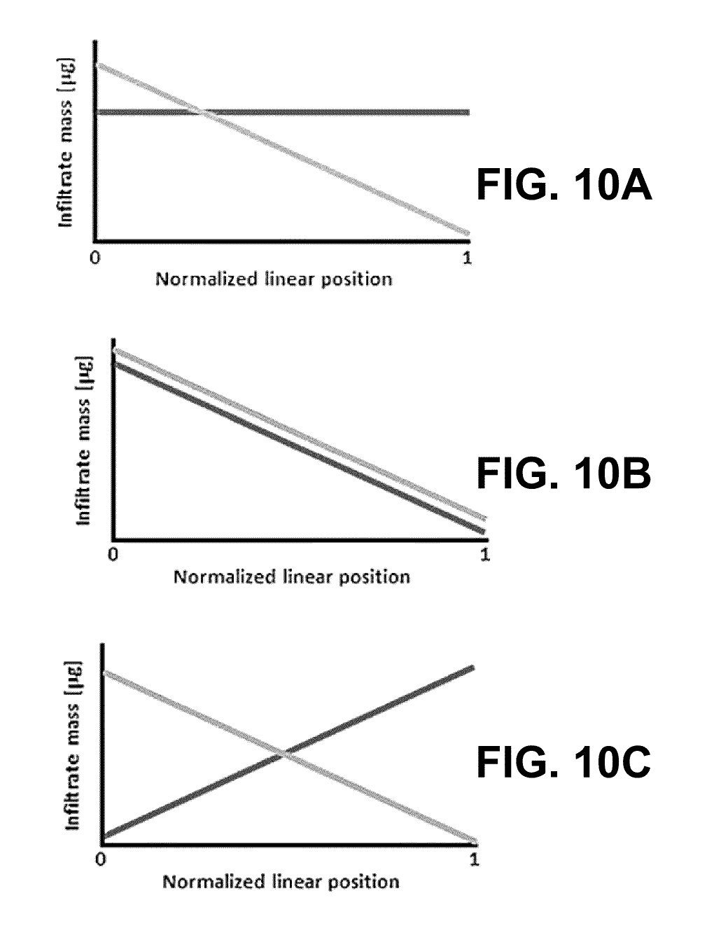

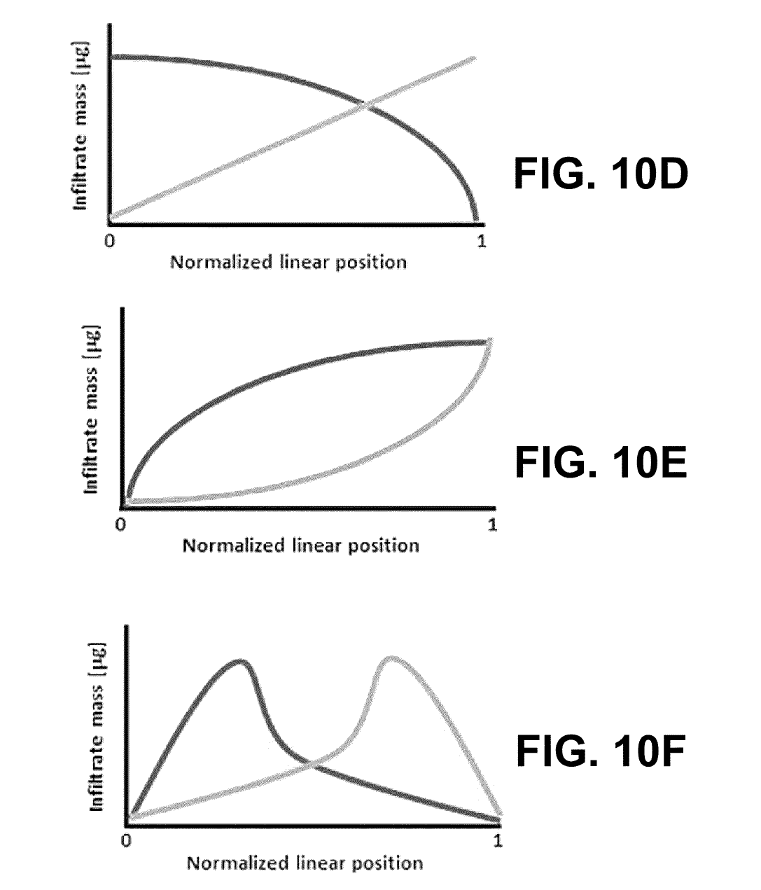

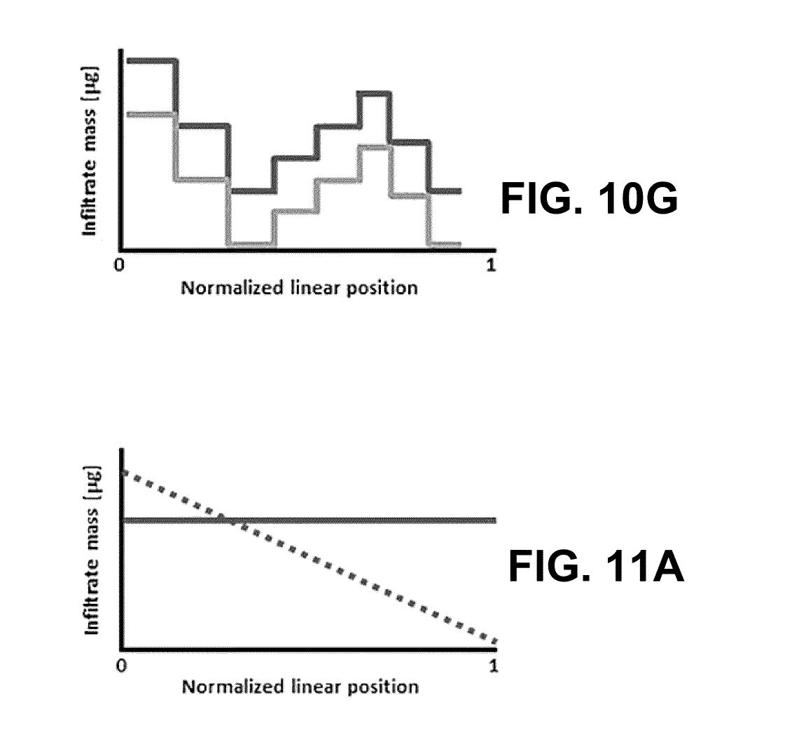

Functional gradation of single (electro)catalytic material in the cell plane of both electrodes can be matched to manage primary local reaction activity. Functionally graded infiltrate can be simultaneously applied to the cathode and the anode to provide additionally effective control over cell operating parameters. All previously described loading distributions can be applied to achieve some final operational targets. A limited set of example combinations is depicted in FIGS. 10A through 10G, though a wide variety of combinations are possible.

FIG. 10A shows an example of a constant or uniform infiltrate distribution across one electrode and a linearly decreasing infiltrate distribution across the other electrode. In other embodiments, the infiltrate distributions may be linearly increasing. FIGS. 10B and 10C illustrate examples of linearly varying infiltrate distributions across the two electrodes in the same and opposite directions, respectively. FIGS. 10D and 10E show examples of combinations of linearly increasing and/or exponentially or quadratically increasing infiltrate distributions on the two electrodes. In other embodiments, other combinations of linearly and/or exponentially or quadratically decreasing (or increasing and decreasing) infiltrate distributions on the two electrodes are possible.

FIG. 10F shows an example of non-linear infiltrate distributions on the two electrodes that include a peak infiltration located between minimum infiltration at the stack (or cell) inlet and outlet. While the distributions are illustrated as mirror opposites in FIG. 10F, other combinations of non-linear distributions with one or more peaks may be utilized. FIG. 10G shows an example of stepped distributions of infiltrates along the lengths of the two electrodes. The infiltrates can be applied to the electrodes with similar distributions as illustrated in FIG. 10G or with different distributions as can be understood. Other combinations of the illustrated infiltrate distributions and/or distributions not depicted in FIGS. 10A-10G can also be used.

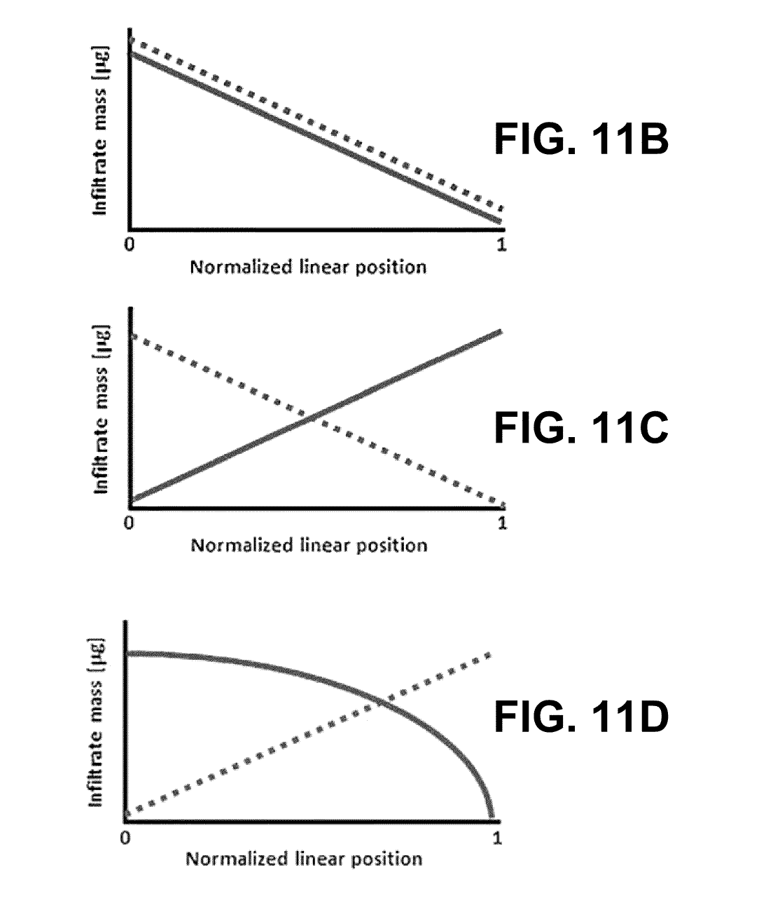

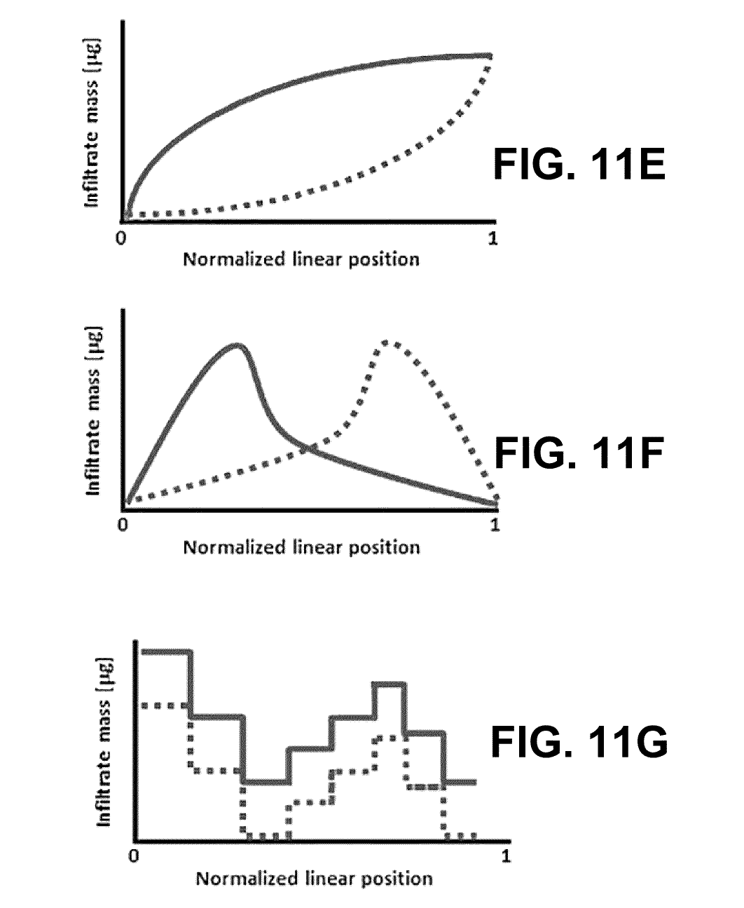

Functionally grading deposition of multiple (electro)catalytic materials in the cell plane can be utilized to manage primary reaction activity. Multiple functionally graded infiltrates could be applied into a single electrode to achieve some complimentary effect within the anode. FIGS. 11A through 11G depicts limited examples of possible combinations of infiltrate distributions on the electrode. While only two infiltrates are illustrated in FIGS. 11A-11G, additional infiltrates can be applied to the electrode as can be understood.

FIG. 11A shows an example of a constant or uniform distribution of a first infiltrate and a linearly decreasing distribution for a second infiltrate. In other embodiments, the infiltrate distributions may be linearly increasing. FIGS. 11B and 11C illustrate examples of linearly varying distributions of infiltrates across the electrode in the same and opposite directions, respectively. FIGS. 11D and 11E show examples of combinations of linearly increasing and/or exponentially or quadratically increasing distributions of infiltrates on the electrode. In other embodiments, other combinations of linearly and/or exponentially or quadratically decreasing (or increasing and decreasing) infiltrate distributions on the electrode are possible.

FIG. 11F shows an example of two non-linear infiltrate distributions on the electrode, which include a peak infiltration located between minimum infiltration at the stack (or cell) inlet and outlet. While the two distributions are illustrated as mirror opposites in FIG. 11F, other combinations of non-linear distributions with one or more peaks may be utilized. FIG. 11G shows an example of two stepped distributions of infiltrates along the length of the electrodes. The infiltrates can be applied to the electrodes with similar distributions as illustrated in FIG. 11G or with different distributions as can be understood. Other combinations of the illustrated infiltrate distributions and/or distributions not depicted in FIGS. 11A-11G can also be used.

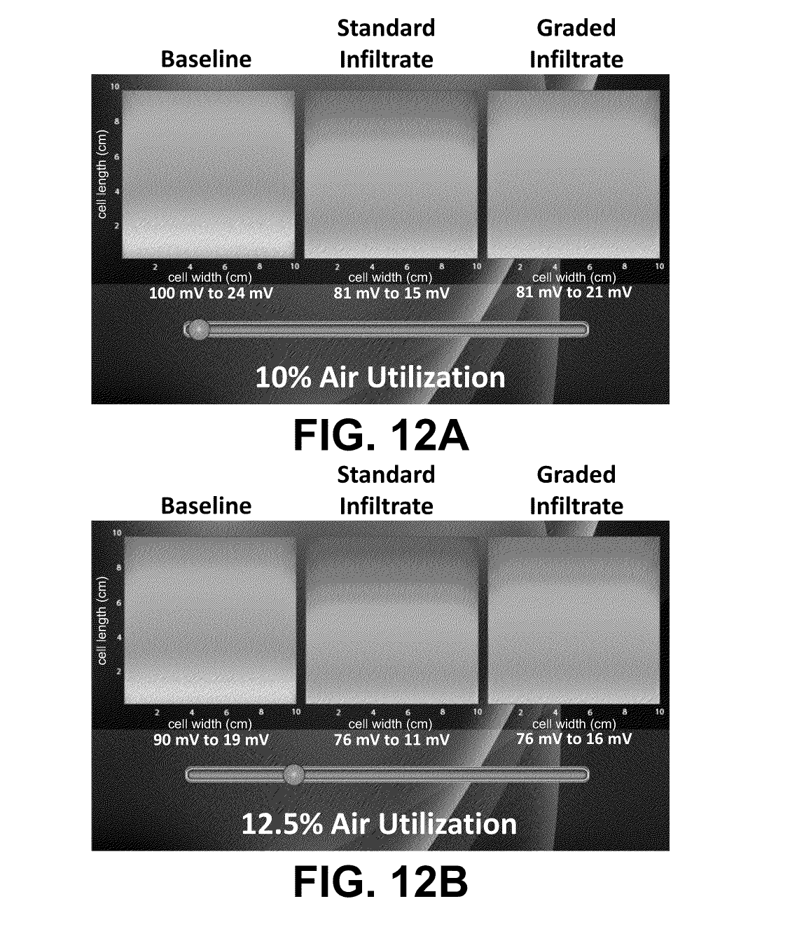

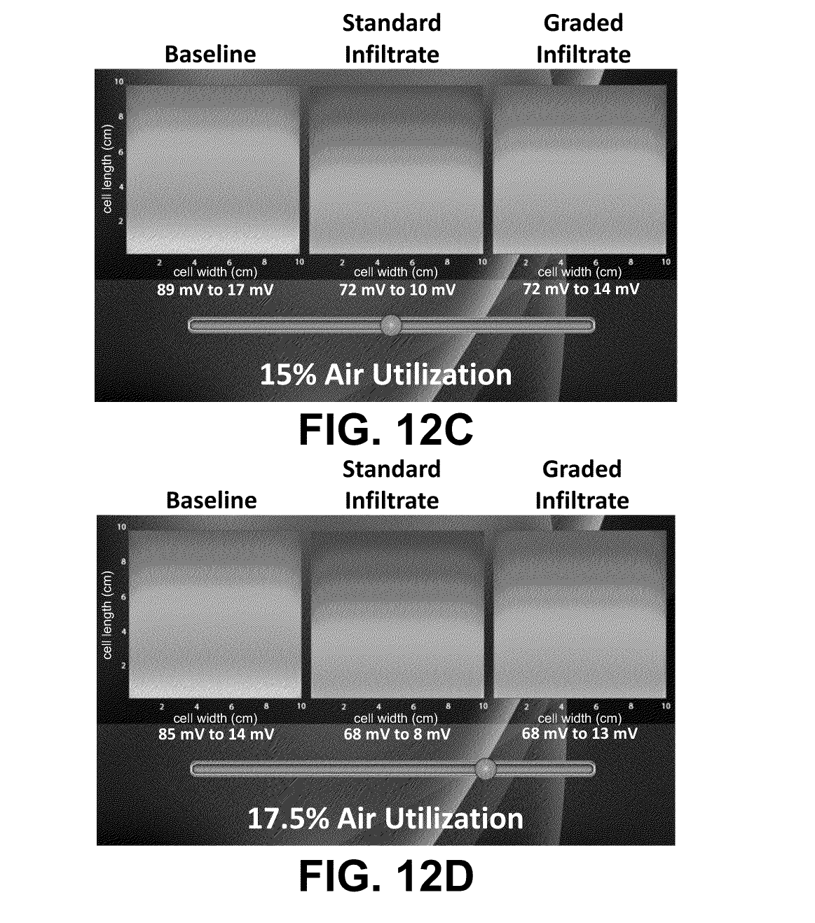

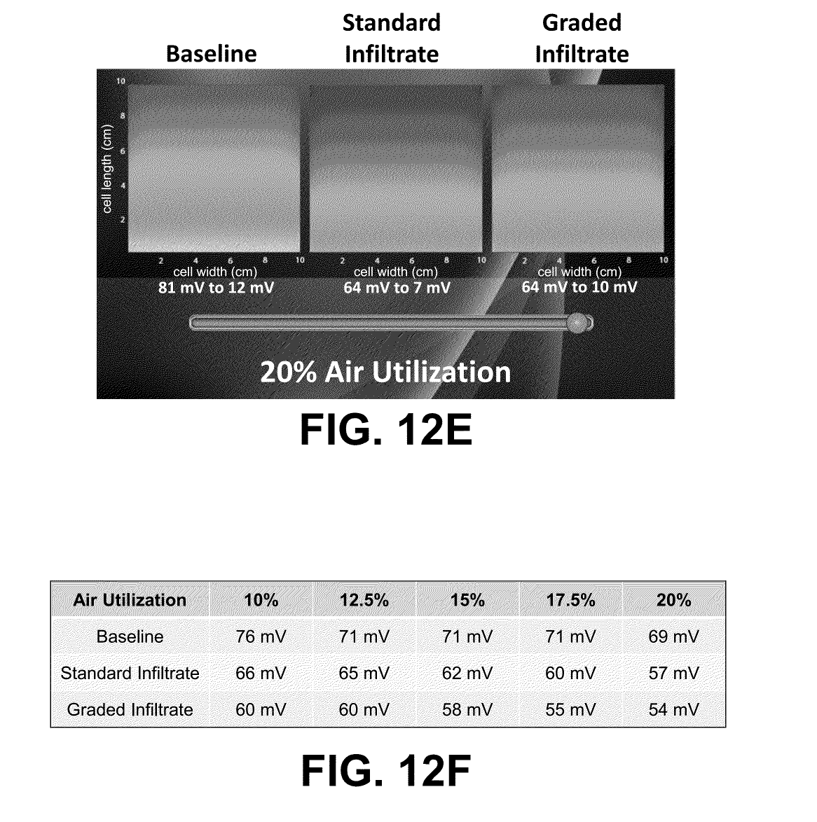

As has been discussed, infiltration provides an additional tool to engineer active electrode interfaces. Functional grading enables control over parameter distributions, both at the cell-to-cell and localized scales. In some cases, it is possible to depress state variable gradients within the SOFC stack. Referring to FIGS. 12A-12E, shown are contours graphically illustrating the control of cell overpotential distribution (in Volts). The simulation was created to examine the role of an infiltrate in controlling the overpotential. The simulation results were based upon full cell multi-physics using ORR developed for LSM. Three cases were considered: a baseline case with no infiltrate (simulation output approximately matched experiments); a standard infiltrate case with infiltrate uniformly applied to the entire cathode; and a graded infiltrate case with infiltrate applied with a one dimensional linear gradient parallel to the gas flow. The simulation baseline was calibrated for approximately 80 mV cathode overpotential at 800° C. and 250 mA/cm² (cell average). The infiltrate was modeled purely as an increase in local activity or ORR.

Simulation of the local overpotential as a function of air utilization assumed 15% as the standard value, with a minimum of 10% utilization and a maximum of 20% utilization. The table of FIG. 12F provides a listing of the cathode overpotential difference from inlet to outlet for the five air utilizations. The results confirm that engineering the cathode overpotential (cathode activity) as a function of position inside the stack is possible. As can be seen in FIG. 12F, the graded infiltrate results in a lower overpotential variation and thus a more uniform utilization of the cell. Infiltration provides a semi-independent technique for engineering stack performance and durability.

The functional grading of one or more electrodes in a SOFC offers a variety of advantages. For example, the local magnitude of deposited (electro)catalyst(s) can be functionally graded with a resultant impact to local electrode activity. This allows for spatial control over local (electro)chemical activity in the electrode, which is not otherwise possible. The functional grading engenders spatial control over chemical activity, which then facilitates control over the local operating state. Controlled parameters include the current density/overpotential and temperature. Local control of the operating state has not been possible, and functional grading embodies an effective (and less expensive) means of establishment.

The application of multiple infiltrates allows for tailoring chemical and electrochemical behaviors as a function of location. The grading distribution can permit partial decoupling of infiltrate functional requirements. More simply, global functional requirements can be achieved using a suite of materials that may exhibit a subset of desirable traits. This can enhance the likelihood of achieving a global performance metric. The functional grading engenders flexibility of electrode engineering to achieve desirable system performance. Conventional electrode and stack engineering uses a blunt method of performance control based on spatially homogenous (in the flow plane) electrode manufacturing, while the functional grading can be used to design a high-performance SOFC stack by engineering electrode microstructure.

In some embodiments, among others, a uniform infiltration of a large cell area to multiple cells assembled in a stack can be used to more coarsely provide control over the operating condition. In another embodiment, graded physical blockage of active regions can be used to restrict access of materials to active interfaces, without affecting electrochemical properties. In another embodiment, functionally grading deposition of multiple (electro)catalytic materials normal to the cell plane can be used to manage primary reaction activity. In another embodiment, functionally grading deposition of the infiltrate can occur in two or three dimensions. In another embodiment, one or more functional grading depositions of single (electro)catalytic materials in the cell plane can be used to suppress primary local reaction activity. In other embodiments, one or more functional grading depositions can be applied to manipulate activity towards secondary reactions, manipulate activity towards reactive degradation processes, and/or manipulate activity towards structural evolution processes. In some embodiments, one or more initial layer(s) can serve as a non-catalytic or support function, with subsequent layers possessing primary activity. In another embodiment, the initial layer(s) serve catalytic or support functions, with subsequent layers serving protective functions.

In some embodiments, among others, an infiltrate can be suitable for application of electro-catalytically active materials into the porous structure of a solid oxide fuel cell cathodes for the purpose of controlling the electrochemical activity. In other embodiments, an infiltrate can be suitable for application of electro-catalytically active materials into the porous structure of solid oxide fuel cell cathodes for the purpose of controlling thermal gradients, local overpotential, or local degradation rates. In some embodiments, a functionally graded infiltrate can be suitable for application of electro-catalytically active materials into the porous structure of solid oxide fuel cell cathodes for the purpose of enhancing the resistance of the cell to thermodynamically induced degradation of active electrode components. In other embodiments, a functionally graded infiltrate suitable for application of electro-catalytically active materials into the porous structure of solid oxide fuel cell cathodes for the purpose of enhancing the resistance of the cell to thermodynamically induced degradation arising from inactive and electrode-intrinsic materials. In some embodiments, an infiltrate can be suitable for application of electro-catalytically active materials into the porous structure of solid oxide fuel cell cathodes for the purpose of enhancing the resistance of the cell to thermodynamically induced degradation arising from electrode-extrinsic materials.

In some embodiments, among others, infiltrate can be functionally deposited to suppress electrode evolution (microstructural, morphological, or chemical) that manifests as degradation of cell performance over periods of time exceeding one hour. Degradation can include any departure of the microstructure, morphology, crystallography, chemistry, or combinations thereof from the designed, engineered, intended, or as-fabricated electrode. Cell performance can be characterized by cell voltage, cell current, cell power, cell resistance or electrode resistivity or area specific resistance, electrochemical impedance analysis, cyclic voltammetry, or other conventional electrochemical techniques.

In other embodiments, infiltrate can be functionally deposited to enhance the electrode's resistance to degradation associated with extrinsically sourced materials (contaminants and impurities). Examples of impurities include, but are not limited to, CO₂, H₂O, chrome and chrome-containing molecules, ammonia, hydrocarbons/organics, volatile and solid metals and compounds, and volatile and solid metalloids and compounds. In some embodiments, infiltrate can be deposited to enhance the electrode's resistance to degradation associated with intrinsically sourced materials, including pre-cursor impurities. Examples of impurities include, but are not limited to, Zr, Y, La, Sr, Co, Fe, Ba, Na, Si, and combinations thereof.

In other embodiments, functional grading can be used to modify the performance of any electrochemical device possessing an active electroceramic electrode, including but not limited to solid oxide electrolysis cells, molten carbonate fuel cells, conventional or advanced electrochemical cells (batteries), conventional or advanced flow batteries, and metal/metal-oxide flow batteries. In other embodiments, functional grading can be used to modify the performance of any electrochemical device possessing an active metal electrode, including but not limited to solid oxide electrolysis cells, molten carbonate fuel cells, conventional or advanced electrochemical cells (batteries), conventional or advanced flow batteries, and metal/metal-oxide flow batteries.

In some embodiments, among others, a system may comprise a plurality of electrodes, where at least one electrode of the plurality of electrodes comprises a non-uniform distribution of an infiltrate applied along a length of the at least one electrode. In some embodiments, among others, the at least one electrode may comprise a cathode comprising a primary ionic conductor and a primary electrode conductor extending between a cathode current collecting layer and an electrolyte. In some embodiments, among others, the at least one electrode may comprise an anode. The non-uniform distribution of the infiltrate may be discontinuous along the length of the at least one electrode. In some embodiments, among others, the at least one electrode may include a second distribution of a second infiltrate. In some embodiments, among others, the second distribution may be a non-uniform distribution. In some embodiments, among others, the infiltrate may comprise a first infiltrate and at least one other electrode of the plurality of electrodes may comprise a second non-uniform distribution of a second infiltrate. In some embodiments, among others, the second infiltrate is the same as the first infiltrate. In some embodiments, among others, the system is a solid oxide fuel cell.

In other embodiments, among others, an electrochemical device may comprise an electrode and a surface-modifying layer disposed in a non-uniform configuration along a surface of the electrode. In some embodiments, among others, the electrode may comprise a primary ionic conductor and a primary electronic conductor extending between a current collecting layer and an electrolyte. In some embodiments, among others, the electrode may comprise a mixed ionic/electronic conductor. In some embodiments, among others, the surface-modifying layer comprises at least one of an ionically conductive infiltrate, an electronically conductive infiltrate, or a mixed ionic/electronic conductive infiltrate. In some embodiments, among others, the electrochemical device may further comprise an additional surface-modifying layer disposed along the surface of the electrode. In some embodiments, among others, the additional surface-modifying layer is non-uniform. In some embodiments, among others, a configuration of the additional surface-modifying layer along the electrode differs from the non-uniform configuration of the surface-modifying layer. In some embodiments, among others, the surface-modifying layer comprises an infiltrate that differs from an infiltrate of the additional surface modifying layer. In some embodiments, among others, the electrode is an active metal electrode. In some embodiments, among others, the electrode is an active electroceramic electrode.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A system, comprising:
a plurality of electrodes, wherein at least one electrode of the plurality of electrodes comprises a non-uniform distribution of an infiltrate applied along a length of the at least one electrode.

2. The system of claim 1, wherein the at least one electrode comprises a cathode.

3. The system of claim 2, wherein the cathode comprises a primary ionic conductor and a primary electronic conductor extending between a cathode current collecting layer and an electrolyte.

4. The system of claim 1, wherein the at least one electrode further comprises an anode.

5. The system of claim 1, wherein the non-uniform distribution of the infiltrate is discontinuous along the length of the at least one electrode.

6. The system of claim 1, wherein the at least one electrode further comprises a second distribution of a second infiltrate.

7. The system of claim 6, wherein the second distribution is a non-uniform distribution.

8. The system of claim 1, wherein the infiltrate comprises a first infiltrate, and at least one other electrode of the plurality of electrodes comprising a second non-uniform distribution of a second infiltrate.

9. The system of claim 8, wherein the second infiltrate is the same as the first infiltrate.

10. The system of claim 1, wherein the system is a solid oxide fuel cell (SOFC).

11. An electrochemical device, comprising:
an electrode; and
a surface-modifying layer disposed in a non-uniform configuration along a surface of the electrode.

12. The electrochemical device of claim 11, wherein the electrode comprises a primary ionic conductor and a primary electronic conductor extending between a current collecting layer and an electrolyte.

13. The electrochemical device of claim 11, wherein the electrode comprises a mixed ionic/electronic conductor.

14. The electrochemical device of claim 11, wherein the surface-modifying layer comprises at least one of: an ionically conductive infiltrate, an electronically conductive infiltrate, or a mixed ionic/electronic conductive infiltrate.

15. The electrochemical device of claim 11, further comprising an additional surface-modifying layer disposed along the surface of the electrode.

16. The electrochemical device of claim 15, wherein the additional surface-modifying layer is non-uniform.

17. The electrochemical device of claim 15, wherein a configuration of the additional surface-modifying layer along the electrode differs from the non-uniform configuration of the surface-modifying layer.

18. The electrochemical device of claim 15, wherein the surface-modifying layer comprises an infiltrate that differs from an infiltrate of the additional surface modifying layer.

19. The electrochemical device of claim 11, wherein the electrode is an active metal electrode.

20. The electrochemical device of claim 11, wherein the electrode is an active electroceramic electrode.
